(19) United States
(12) Patent Application Publication
(10) Pub. No.: US 2013/0173826 A1
(43) Pub. Date: Jul. 4, 2013

(54) METHOD OF PROVIDING TIMING INFORMATION USING MMT SIGNALING LAYER SIGNALING FOR SYNCHRONIZING MMT PACKET STREAMS IN MMT HYBRID DELIVERY SERVICE AND METHOD OF SYNCHRONIZING MMT PACKET STREAMS IN MMT HYBRID DELIVERY SERVICE

(71) Applicant: ELECTRONICS AND TELECOMMUNICATIONS RESEARCH INSTITUTE, Daejeon-si (KR)

(72) Inventors: Sung Hei KIM, Daejeon-si (KR); Kwang Deok SEO, Wonju-si (KR); Tae Jun JUNG, Wonju-si (KR); Chang Kyu LEE, Daejeon-si (KR); Shin Gak KANG, Daejeon-si (KR)

(73) Assignee: ELECTRONICS AND TELECOMMUNICATIONS RESEARCH INSTITUTE, Daejeon-si (KR)

(21) Appl. No.: 13/714,291

(22) Filed: Dec. 13, 2012

(30) Foreign Application Priority Data
Dec. 30, 2011 (KR) 10-2011-0147703

(51) Int. Cl. H04L 29/06

(52) U.S. Cl. CPC H04L 65/10
USPC 709/248

(57) ABSTRACT

A method for providing timing information for synchronizing between packet streams each transported from a first server and a second server under environment of a hybrid delivery service is provided. When the first server transports a first media entity and the second server transports a second media entity, timing information for synchronizing a second packet including a second media entity with a first packet including a first media entity in the second server is generated in response to a transport request for the second media entity from a client and the timing information and the second packet including the second media entity is provided to the client from the second server.

### CROSS-REFERENCE TO RELATED APPLICATIONS

This application claims the benefit of priority of Korean Patent Application No. 10-2011-0147703 filed on Dec. 30, 2011, all of which are incorporated by reference in their entirety herein.

### BACKGROUND OF THE INVENTION

1. Field of the Invention

The present invention relates to a method of providing timing information and a synchronization method so as to provide multimedia application services, and more particularly, to a method for providing timing information and a synchronization method so as to allow a plurality of media entities configuring one service to provide multimedia application services in a hybrid delivery service transported from different servers.

2. Related Art

An MPEG media transport (MMT) is a new media transport standard technology that starts to be developed in a moving picture experts group (MPEG) systems sub-working group.

The existing MPEG-2 system standardizes an MPEG-2 transport stream (TS) technology as a standard for functions of packetization, synchronization, multiplexing, and the like, required to transport audio video (AV) contents in a broadcast network, which has been currently widely used. However, the MPEG-2 TS is inefficient under the packet transport environment in which the network is based on an internet protocol (IP).

Therefore, the ISO/IEC/JTC1/SC29/WG11 MPEG recognizes a necessity of a new media transport standard in consideration of new media transport environment and future media transport environment and starts MMT standardization.

In connection with the standardization of the MMT progressed in the MPEG at June 2011, a technology under consideration (TuC) document and Working Draft (WD) version 2.0 ISO/IEC/JTC1/SC29/WG 11 N11953 “Working Draft of MPEG Media Transport” (Geneva, Switzerland in March 2011) have been pronounced.

In the MPEG media transport (MMT) service, a plurality of media data may be transported to a single client apparatus through different channels or a network by using different servers in a heterogeneous network environment. In case of the hybrid delivery environment, the client apparatus may serve the plurality of received media streams in an integrated type while being synchronized.

However, a synchronization method for serving the plurality of media entities in a single integrated type in the client apparatus receiving the plurality of transported media entities under different heterogeneous network environments has not yet been provided.

That is, it is difficult for a timing model based on a decoding timestamp (DTS), a presentation timestamp (PTS), and a program clock reference (PCR) of the MPEG-2 system that is the media synchronization method used for the related art and a timing model based on the RTP timestamp to efficiently synchronizing between media for providing media services under the hybrid delivery environment.

In particular, when the MMT data stored in a storage of the server in advance are transported through a channel different from the channel through which the MMT media streams are served, a signaling method required to perform services while being synchronized with the currently served MMT streams has not yet been proposed.

When the plurality of media data are transported from different servers belonging to the heterogeneous network environment, the problems of application of the timing model based on the DTS, the PTS, and the PCR provided in the existing MPEG-2 system may occur.

All of the DTS, PTS, PCR clock values are generated while meeting a local system time clock (STC) adopted in a specific transport server. When the DTS, PTS, and PCR clock values for any media streams are generated from the local STC of the server called A and the DTS, PTS, and PCR clock values for another stream to synchronize between the media streams are generated in the local STC of the server called B, the streams generated from different servers using different STCs do not have time information that can be commonly used. Therefore, it is impossible for the timing model of the MPEG-2 system to synchronize between the streams generated and transported in different servers.

Meanwhile, the delivery service based on the RTP protocol is based on a principle of synchronizing between the real-time media streams using the RTP timestamp and the NTP timestamp but using the NTP timestamp information generated during the real-time service, such that it is actually impossible to synchronize the media data stored in the storage of the server in advance with another stream served in real time by another server.

### SUMMARY OF THE INVENTION

The present invention provides a method for providing timing information for synchronizing between packet streams each transported from a first server and a second server so as to smoothly provide multimedia application services under environment of a hybrid delivery service.

The present invention also provides a method for synchronizing between packet streams each transported from a first server and a second server so as to smoothly provide multimedia application services under environment of a hybrid delivery service. The present invention also provides a server for providing timing information for synchronizing between packet streams each transported from a first server and a second server so as to smoothly provide multimedia application services under environment of a hybrid delivery service.

In an aspect, there is provided a method for providing timing information for synchronizing between packet streams each transported from a first server and a second server under environment of a hybrid delivery service, wherein the first server transports a first media entity and the second server transports a second media entity, including: generating timing information for synchronizing a second packet including a second media entity with a first packet including a first media entity in the second server in response to a transport request for the second media entity from a client; and providing the timing information and the second packet including the second media entity to the client from the second server. The timing information may be transported to the client, being included in a signaling message of an MMT S.2 layer. The client may calculate a network time protocol (NTP) timestamp value NTP0 of an MMT packet first received from the first server, an NTP timestamp NTP_{cur} at the time of a transport request for the second media entity to the first packet including the first media entity transported from the first server and arriving at the client, and an NTP timestamp NTP_{syn} at the time of synchronization with the second media entity to be newly received in future by the following Equation. NTP_{syn}=NTP_{cur}+α, where α represents a delay time expected until the second packet including the second media entity is transported from the second server after a switching request to the second media entity and arrives at the client. The generating of the timing information for synchronizing the second packet including the second media entity in the second server with the first packet including the first media entity in response to the transport request for the second media entity from the client may further include calculating Start_Time_Offset that is a temporal difference value between an original start time and an actual start time of the second media entity service in the second server as a universal time coordinated (UTC) time format by the following Equation. Start_Time_Offset=NTP_{syn}−NTPo The generating of the timing information for synchronizing the second packet including the second media entity in the second server with the first packet including the first media entity in response to the transport request for the second media entity from the client may further include calculating a Start_Clock_Offset value obtained by converting the Start-Time-Offset with system clock frequency (SCF) precision of a system time clock (STC) of the second server by the following Equation. Start_Clock_Offset=Start_Time_Offset×SCF. The generating of the timing information for synchronizing the second packet including the second media entity in the second server with the first packet including the first media entity in response to the transport request for the second media entity from the client may further include calculating a sampling time STₖ corresponding to an actual start time of the second media entity by the following Equation so as to detect a temporal position of an MMT data corresponding to the Start_Clock_Offset value. STₖ=STₒ+Start_Clock_Offset, where STₒ is a sampling time corresponding to an original start time of the second media entity. The second server may include the NTP timestamp corresponding to the actual start time of the second media entity in the signaling message of the MMT S.2 layer so as to be transported to the client. The second server may be a supplemental information server transporting data including supplemental information through a broadband channel and the first server may be a program stream server transporting data including broadcast contents through a broadcast channel.

In another aspect, there is provided a method for synchronizing between packet streams each transported from a first server and a second server under environment of a hybrid delivery service, including: requesting transport of a second media entity to a second server through a second network during playing of a first media entity received through a first network from the first server in a client; receiving timing information for synchronizing a second packet including the second media entity with a first packet including the first media entity in the client from the second server; and determining whether the first packet including the first media entity and the second packet including the second media entity are synchronized with each other by using the timing information in the client. The client may receive the timing information included in the signaling message of the MMT S.2 layer from the second server. The client may calculate a network time protocol (NTP) timestamp value NTP0 of an MMT packet first received from the first server, an NTP timestamp NTP_{cur} at the time of a transport request for the second media entity to the first packet including the first media entity transported from the first server and arriving at the client, and an NTP timestamp NTP_{syn} at the time of synchronization with the second media entity to be newly received in future by the following Equation. NTP_{syn}=NTP_{cur}+α, where α represents a delay time expected until the second packet including the second media entity is transported from the second server after a switching request to the second media entity and arrives at the client. The determining whether the first packet including the first media entity and the second packet including the second media entity are synchronized with each other by using the timing information in the client may perform synchronization when a difference value between first absolute time information Absolute_Presentation_Time of the first packet and second absolute time information Absolute_Presentation_Time of the second packet is smaller than the reference value to play the first and second packets together.

In another aspect, there is provided a server for providing timing information so as to synchronize between packet streams each transported from a first server and a second server under environment of a hybrid delivery service, wherein the first server transports a first media entity and the second server transports a second media entity, including: a timing information generation unit generating timing information for synchronizing a second packet including a second media entity with a first packet including a first media entity by the second server in response to a transport request for the second media entity from a client; an MMT packet generation unit packetizing and generating the packets including the second media entity, and an MMT packet transport unit transporting the packet including the generated second media entity to the client. The timing information generation unit may include the timing information included in a signaling message of an MMT S.2 layer so as to be transported to the client.

### BRIEF DESCRIPTION OF THE DRAWINGS

FIG. 1 is a conceptual diagram showing an MMT hierarchical structure.

FIG. 2 is a flow chart showing a data exchange procedure between a plurality of servers and an MMT client including an MMT receiving system according to an exemplary embodiment of the present invention under the MMT hybrid delivery service environment.

FIG. 3 is a diagram showing MMT packet streams and NTP timestamp information included in MMT packets that are transported to an MMT client apparatus by a first server (program stream server) of FIG. 2.

FIG. 4 is a diagram showing the relationship between an NTP timestamp NTP_{cur} when the MMT client apparatus requests a new SDH subtitle to the MMT packets related to a movie transported by the first server (program stream server) and an NTP timestamp (NTP_{syn}) when synchronization with an SDH subtitle to be newly received in future is made.

FIG. 5 is a diagram showing the timing relationship between the MMT data to be considered by the second server (supplemental information server) when the SDH subtitle data stored as a storage format of the MMT in the second server (supplemental information server) and the SDH subtitle data requested from the MMT client apparatus are transported by being carried on the MMT packet.

FIG. 6 is a flow chart showing in detail a process of FIG. 2.

FIG. 7 is a block diagram of a server providing timing information according to an exemplary embodiment of the present invention.

### DESCRIPTION OF EXEMPLARY EMBODIMENTS

Since the present invention may be variously modified and have several exemplary embodiments, specific exemplary embodiments will be shown in the accompanying drawings and be described in detail.

However, it is to be understood that the present invention is not limited to the specific exemplary embodiments, but includes all modifications, equivalents, and substitutions included in the spirit and the scope of the present invention.

Terms used in the specification, ‘first’, ‘second’, etc., may be used to describe various components, but the components are not to be construed as being limited to the terms. That is, the terms are used to distinguish one component from another component. Therefore, the first component may be referred to as the second component, and the second component may be referred to as the first component. The term ‘and/or’ includes a combination of a plurality of items or any one of a plurality of terms.

It is to be understood that when one element is referred to as being “connected to” or “coupled to” another element, it may be connected directly to or coupled directly to another element or be connected to or coupled to another element, having the other element intervening therebetween. On the other hand, it is to be understood that when one element is referred to as being “connected directly to” or “coupled directly to” another element, it may be connected to or coupled to another element without the other element intervening therebetween.

Specific terms will be used in the exemplary embodiments of the present invention for clarity of the contents therein. However, the present invention is not limited to the specific terms selected therein but includes all technical synonyms operating in the same method so that each of the specific terms accomplish similar objects. Singular forms are intended to include plural forms unless the context clearly indicates otherwise. It will be further understood that the terms “comprises” or “have” used in this specification, specify the presence of stated features, steps, operations, components, parts, or a combination thereof, but do not preclude the presence or addition of one or more other features, numerals, steps, operations, components, parts, or a combination thereof.

Unless indicated otherwise, it is to be understood that all the terms used in the specification including technical and scientific terms has the same meaning as those that are understood by those who skilled in the art. It must be understood that the terms defined by the dictionary are identical with the meanings within the context of the related art, and they should not be ideally or excessively formally defined unless the context clearly dictates otherwise.

Hereinafter, exemplary embodiments of the present invention will be described in more detail with reference to the accompanying drawings. In order to facilitate the general understanding of the present invention in describing the present invention, through the accompanying drawings, the same reference numerals will be used to describe the same components and an overlapped description of the same components will be omitted.

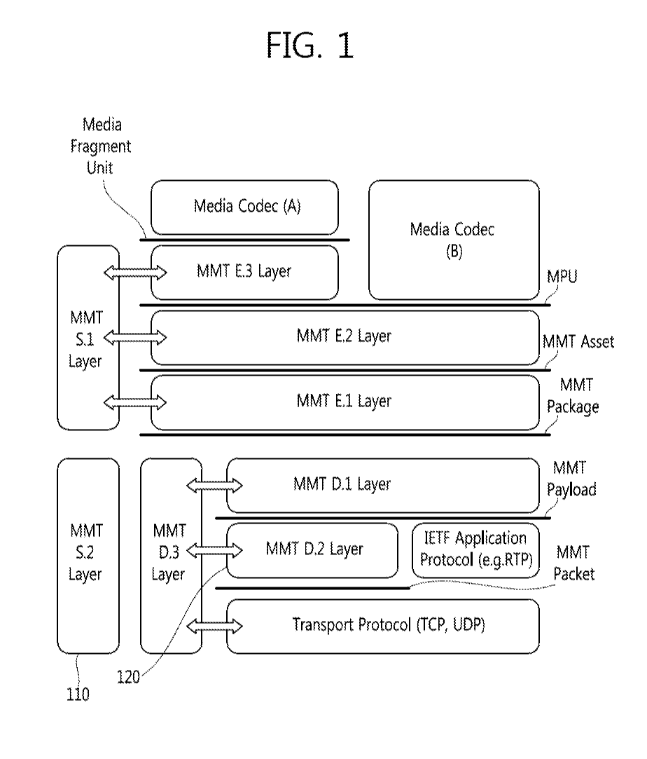

FIG. 1 is a conceptual diagram showing an MMT hierarchical structure.

Referring to FIG. 1, the MMT hierarchy includes functional areas of an encapsulation layer, a delivery layer, and a signaling layer. The MMT hierarchy is operated over a transport layer.

The encapsulation layer (E-layer) may serve to perform packetization, fragmentation, synchronization, multiplexing, and the like, that are, for example, transported media.

The E-layer may be configured of an MMT E.1 layer, an MMT E.2 layer, and an MMT E.3 layer as shown in FIG. 1.

The E.3 layer encapsulates a media fragment unit (MFU) provided from a media codec (A) layer to generate an media processing unit (MPU).

The MFU may have a format carrying the data unit that can be independently consumed by a media decoder, regardless of any specific codec. The MFU may be, for example, a picture or a slice of video.

The media processing unit (MPU) may be configured of one or a plurality of MFUs and may have a format carrying one or a plurality of access units, regardless of the specific codec.

The E.2 layer encapsulates the MPU generated in the E.3 layer to generate an MMT asset.

The MMT asset, which is data entity configured of one or a plurality of MPU from a single data source, is a data unit in which composition information and asset delivery characteristics are defined. The MMT asset may correspond to packetized elementary streams (PES), for example, video, audio, program information, MPEG-U widget, JPEG image, MPEG-4 file format, MPEG transport stream (M2TS),m and the like.

The E.1 layer encapsulates the MMT asset generated in the E.2 layer to generate the MMT package.

The MMT package may be configured of one or a plurality of MMT assets, together with composition information and asset delivery characteristics. The composition information includes information on the relationship between the MMT assets and when one content is configured of a plurality of MMT packages, may further include the information showing the relationship between the plurality of MMT packages. The asset delivery characteristics may include the asset delivery characteristic information required to determine the delivery condition of the MMT asset or the MMT packet, for example, a traffic descriptor parameter and QoS descriptor. The MMT package may correspond to the program of the MPEG-2 TS.

The delivery layer may perform network flow multiplexing, network packetization, QoS control, and the like, of media transported through, for example, a network.

The delivery layer (D-layer) may be configured of an MMT D.1 layer, an MMT D.2 layer, and an MMT D.3 layer, as shown in FIG. 1.

The D.1-layer receives the MMT package generated in the E.1 layer to generate an MMT payload. The MMT payload transports the MMT asset and is a payload for transporting information for consumption by an MMT protocol or other existing application transport protocols such as RTP. The MMT payload may include the fragment of the MFU together with the information such as AL-FEC.

The D.2-layer receives the MMT payload generated in the D.1 layer to generate the MMT packet. The MMT packets are a data format used for the application transport protocol for the MMT.

The D.3-layer provides a function of exchanging information between layers by a cross-layer design to support the QoS. For example, the D.3-layer may use a QoS parameter of an MAC/PHY layer to perform the QoS control.

The signaling layer may perform functions such as session initialization/control/management of the transported media, server based and/or client based trick mode, service discovery, synchronization, and the like.

The signaling layer (S-layers) may be configured of the MMT S.1 layer and the MMT S.2 layer as shown in FIG. 1.

The S.1 layer may perform functions to control media consumption, such as service discovery, media session initialization/termination, media session presentation/control, interface between the delivery (D) layer and the encapsulation (E) layer, and the like. The S.1 layer may define a format of the signaling messages between applications for media presentation session management.

The S.2 layer may define a format of the signaling message exchanged between delivery end-points of the delivery layer (D-layer) regarding media delivery control such as flow control, delivery session management, delivery session monitoring, error control, and hybrid network synchronization control.

The S.2 layer may include delivery session establishment and release, delivery session monitoring, flow control, error control, resource reservation for established delivery session, signaling for synchronization under the hybrid delivery environment, and signaling for adaptive delivery so as to support an operation of the delivery layer. It is possible to provide required signaling between a sender and a receiver. That is, the S.2 layer may provide the required signaling between the sender and the receiver so as to support an operation the delivery layer as described above. In addition, the S.2 layer may perform an interface function between the delivery layer and the encapsulation layer.

In particular, the S.2 layer is configured to include the timing information for synchronizing between the packet streams transported through the first network from the first server and the packet streams transported through the first network from the second server under the hybrid delivery environment in the signaling message of the S.2 layer to perform a media delivery control so that the packet streams transported from the first server and the packet streams transported from the second server are synchronized with each other. That is, when the original MMT packet requested by the user is transported from the server to the client apparatus, prior to transporting the original MMT packet, an m out-of-band signaling type including the timing information for synchronization in the signaling message of the S.2 layer so as to be transported from the server to the client apparatus may be used. In addition, when the client apparatus receives the first MMT packet from the server and then, requires the synchronization between the plurality of media entities, the client apparatus can confirm and process the synchronization between the plurality of media entities transported through the heterogeneous network under the hybrid delivery environment using the timing information received from the server.

The timing information may be transported by being included in, for example, the signaling message of the MMT S layer shown in FIG. 1. In detail, the timing information may be transported by being included in the signaling message of the MMT S.2 layer or the signaling message of the MMT S.1 layer shown in FIG. 1.

The client receiving the MMT packets calculates absolute time information of each media entity for synchronization of each media entity transported from the plurality of different servers using the timing information, thereby implementing the synchronization of each media entity transported from the plurality of different servers under the heterogeneous network environment.

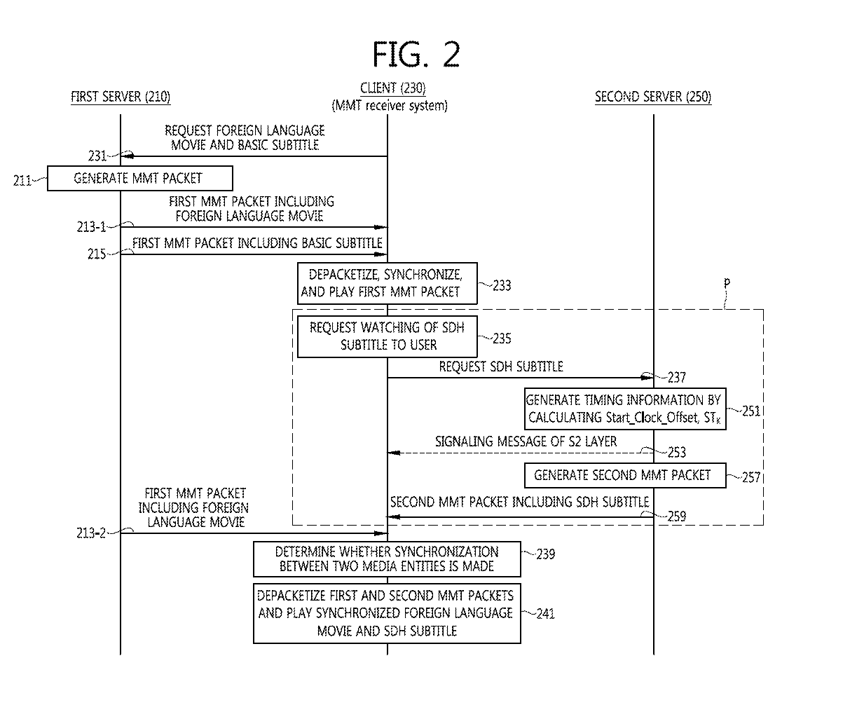

FIG. 2 is a flow chart showing a data exchange procedure between the plurality of servers and the MMT client including an MMT receiving system according to an exemplary embodiment of the present invention under the MMT hybrid delivery service environment.

In detail, FIG. 2 is a diagram exemplarily showing a data exchange procedure between the plurality of servers and the MMT client under the hybrid delivery service environment that the plurality of media entities configuring one service are transported from the plurality of different servers. FIG. 2 shows, for example, the case in which the plurality of servers are two servers, a first server 210 and a second server 250, but the present invention may also be applied to the case in which the data exchange between at least three different servers and the client is performed.

In this case, the first server 210 may be a program stream server and the second server 250 may be a supplemental information server. Alternatively, the first server 210 may be a server providing a 3D left video and the second server 250 may be a server providing a 3D right video, but the present invention is not limited thereto. Therefore, the first server and the second server may be a server transporting different media entities through a network having different delay characteristics.

Hereinafter, the data exchange procedure among the MMT client 230 receiving the MMT packets, the program stream server 210, and the supplemental information server 250, for example, the method for providing timing information for synchronizing the MMT packet streams in the MMT hybrid delivery service according to the exemplary embodiment of the present invention will be described with reference to FIG. 2.

Hereinafter, the case in which the first server 210, which is the program stream server, transports data of broadcast contents, and the like, such as foreign language movies to the MMT client 230 through a broadcast network or a broadcast channel and the second server 250, which is the supplemental information server, transports the supplemental information such as a subtitles for the deaf and hard-of-hearing (SDH) subtitle (sign language subtitle) of the foreign language movies through a broadband network such as an IP network or a broadband channel to the MMT client 250 will be described by way of example.

First, the MMT client 230 transports a message 231 requesting a foreign language movie and a basic subtitle to the first server 210.

The first server 210 packetizes the requested foreign language movie and basic subtitle into each MMT packet to generate the MMT packets including the requested foreign language movie and basic subtitle (S211) and transport the generated MMT packets to the MMT client 230. In this case, as shown in FIG. 2, each MMT packet may be separately generated as a first MMT packet 213-1 including a movie and a second MMT packet 215 including a subtitle so as to be transported in a streaming type.

The MMT client 230 receiving the MMT packets 213-1 and 215 depacks or depacketizes the received MMT packets 213-1 and 215 to synchronize and play the movie video and subtitle (S233).

When a user requests the watching of the SDH subtitle (S235), the MMT client apparatus 230 transports an SDH subtitle request message 237 to the second server 250.

The second server 250 receiving the SDH subtitle request message calculates Start_Clock_Offset and the STₖ value to generate the timing information (S251). Here, the Start_Clock_Offset is a result value obtained by converting Start_Time_Offset that is a temporal difference value between the original start time and the actual start time of the media entity (SDH subtitle data) requested from the MMT client apparatus 230 into the same clock unit as the sampling time included in a header portion of each MMT storage data. The STₖ value, which is the sampling time recorded in the header of the MMT storage data, is the sampling time that is the actual start time of the actual SDH subtitle service.

The second server 250 includes the timing information in the signaling message of the MMT S layer, for example, the signaling message of the MMT S.2 layer so as to be transported to the MMT client apparatus 230 (S253).

The second server 250 MMT-packetizes the SDH subtitle requested from the MMT client apparatus 230 to generate the second MMT packet including the SDH subtitle (S257).

The second server 250 transports the MMT packets including the SDH subtitle to the MMT client apparatus 230 (S259).

The second server 250 may include the timing information in the signaling message of the S layer followed by the transport of the second MMT packet including the SDH subtitle so as to be transported to the MMT client apparatus 230. FIG. 2 shows the case in which the transporting of the signaling message of the S layer to the MMT client apparatus 230 (S253) is first performed generating the second MMT packet including the SDH subtitle (S257), but the transporting of the signaling message of the S layer to the MMT client apparatus 230 (S253) may also be performed after the generating of the second MMT packet including the SDH subtitle (S257) or before the transporting of the second MMT packet including the SDH subtitle.

The MMT client apparatus 230 determines whether the two media entities are synchronized (S239). In detail, the MMT client apparatus 230 may determine whether the synchronization between two media entities is performed through each Absolute_Presentation_Time (APT) value of an i-th MMT packet for media entity 1 (foreign language movie) streamed from the first server 210 and a j-th MMT packet for media entity 2 (SDH subtitle) transported from the second server 250.

That is, the MMT client apparatus 230 calculates the APTs of the received MMT packets for each network or channel so as to synchronize the plurality of MMT packets transported through different networks or channels from different servers like the first server 210 and the second server 250 and the MMT client apparatus 230 compares the difference value of each of the obtained APTs with appropriately set reference value (Δ value) in consideration of temporal precision of synchronization to determine whether the synchronization is made. That is, the MMT client apparatus 230 obtains each of the APT values of the i-th MMT packet received from the first server 210 and the j-th MMT packet received from the second server 250 to determine whether the synchronization is made in the case in which the difference value between two values is smaller than the Δ value representing temporal precision of the synchronization, thereby playing the two MMT packets together. When the difference value between the two APT values is larger than the Δ value, it is possible to search and play a combination of the MMT packets satisfying the value smaller than the Δ value. In this case, the Δ value represents a synchronization bound and may be determined as an appropriate value in consideration of the synchronization precision. The case in which the Δ value is 0 may be used in the case in which the complete synchronization between the two MMT streams is made. To this end, this can be made when the two MMT streams transported from different servers is operated based on the STC of the same resolution. The case in which the Δ value is 0 may be used, for example, in the case in which the synchronization between the MMT stream for the left video and the MMT stream for the right video of the 3D video requiring the complete synchronization is made.

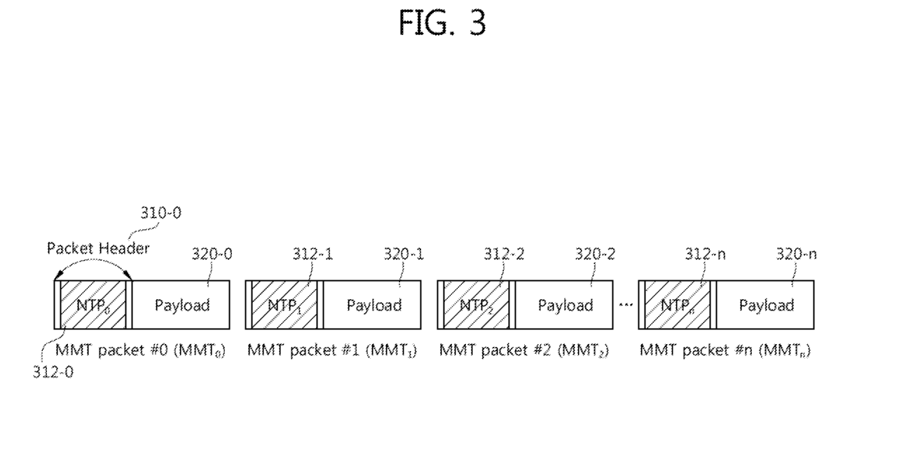

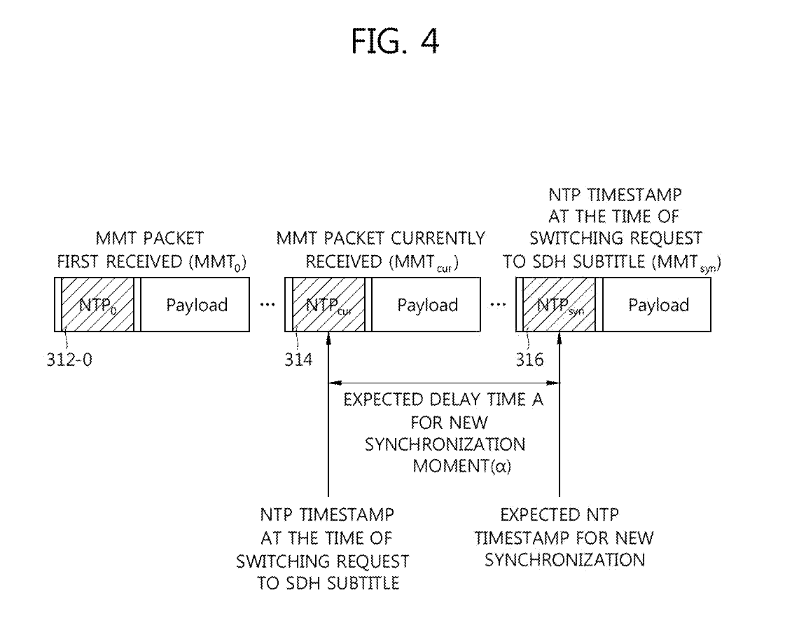

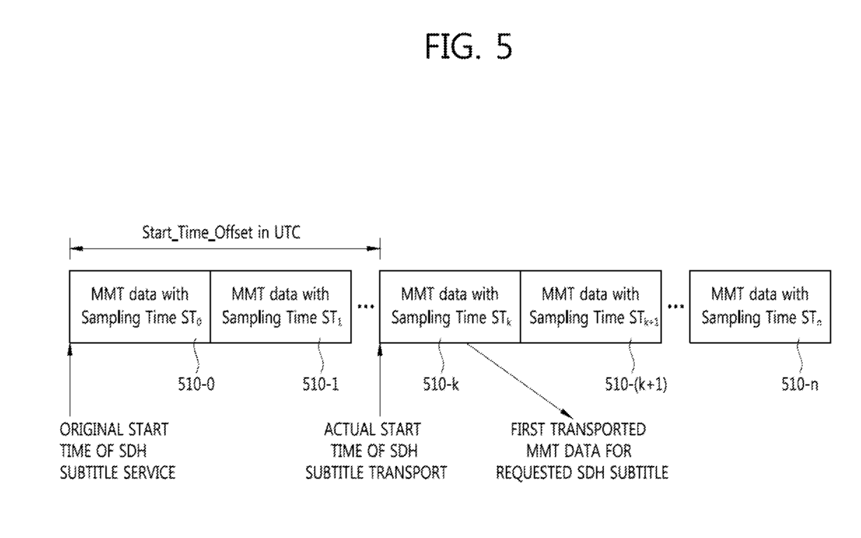

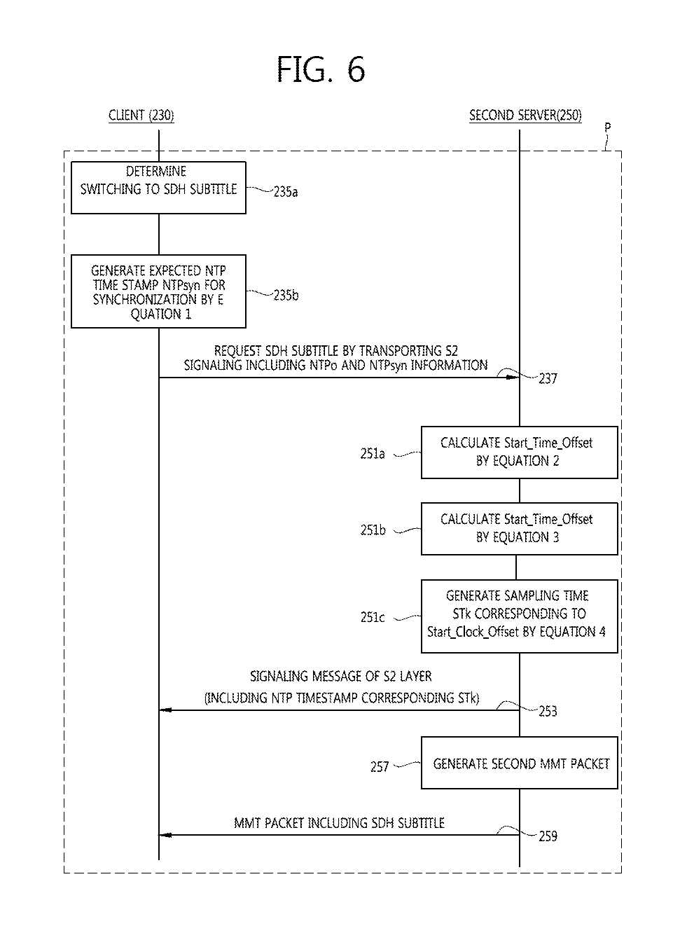

The MMT client apparatus 230 depacks or depacketizes the first MMT packet 213-2 including the foreign language movie received from the first server 210 and the MMT packets 259 including the SDH subtitle received from the second server 250, respectively, when the synchronization is made as the determination result whether the synchronization is made to synchronize the streams received from the first server 210 with the subtitle data received from the second server 250, thereby playing the foreign language movie and the SDH subtitle so as to be synchronized with each other (S241). FIG. 3 is a diagram showing the MMT packet streams and the NTP timestamp information included in the MMT packets that are transported to the MMT client apparatus by the first server (program stream server) of FIG. 2. FIG. 4 is a diagram showing the relationship between the NTP timestamp NTP_{cur} when the MMT client apparatus requests a new SDH subtitle to the MMT packets related to a movie transported by the first server (program stream server) and the NTP timestamp (NTP_{syn}) when the synchronization with an SDH subtitle to be newly received in future is made. FIG. 5 is a diagram showing the timing relationship between the MMT data to be considered by the second server (supplemental information server) when the SDH subtitle data stored as a storage format of the MMT in the second server (supplemental information server) and the SDH subtitle data requested from the MMT client apparatus are carried on the MMT packets. FIG. 6 is a flow chart showing in detail a p process of FIG. 2.

Hereinafter, the method for providing timing information for synchronizing between the first MMT packet including the foreign language movie transported from the first server and the second MMT packet including the SDH transported from the second server in connection with the request for the watching of the SDH subtitle by the user of FIG. 2 will be described in detail with reference to FIGS. 3 to 6.

Referring first to FIG. 6, when the user requests the watching of the SDH subtitle, the MMT client apparatus 230 determines the switching to the SDH subtitle (S235a), the MMT client apparatus 230 generates the expected NTP timestamp NTP_{syn} for synchronization by using an NTP timestamp value NTP0 312-0 for the MMT packet MMT0 first reached at the MMT client apparatus 230 from the first server 210 (program stream server) by the following Equation 1 and an expected delay time a when the SDH subtitle data are transported to the MMT client apparatus 230 from the second server 250 (supplemental information server) (S235b), and transports the SDH subtitle request message to the second server 250 through the signaling of the S layer, for example, the S.2 layer including the NTP timestamp value NTP0 312-0 and the NTP timestamp NTP_{syn} for the MMT packet MMT0 (S237).

Hereinafter, the NTP timestamp value NTP0 312-0 and the NTP timestamp NTP_{syn} for the MMT packet MMT0 will be described with reference to FIGS. 3 and 4.

Referring to FIG. 3, in order to smoothly provide the synchronization between various types of media in the hybrid delivery service, the network time protocol (NTP) timestamp information may be included in the header 310-0 of the MMT packet.

Each MMT packet is configured of the NTP timestamp value and a payload. That is, the MMT packet MMT0 first reached at the MMT client apparatus 230 is configured of the NTP timestamp value NTP0 312-0 and a payload 312-0, an MMT packet MMT1 first reached after the first reached MMT packet MMT0 is configured of the NTP timestamp value NTP1 312-1 and a payload 312-1, an MMT packet MMT2 second reached after the first received MMT packet MMT0 is configured of the NTP timestamp value NTP2 312-2 and a payload 312-2, and an MMT packet MMTn n-th received after the first received MMT packet MMT0 is configured of the NTP timestamp value NTPn 312-n and a payload 312-n.

The synchronization between the MMT media streams related to the movie transported by the first server 210 (program stream server) and the MMT media streams related to the basic subtitle may be made using the NTP timestamp information. In addition, the temporal synchronization between the MMT media streams transported from different servers may be made in the hybrid delivery environment by using the NTP timestamp information.

FIG. 4 is a diagram showing the relationship between the NTP timestamp NTP_{cur} 314 when a new SDH subtitle is requested to the MMT packets related to the movie arriving at the MMT client apparatus and transported by the first server 210 (program stream server) and the NTP timestamp (NTP_{syn}) 316 when the synchronization with the SDH subtitle to be newly received in future is made.

FIG. 4 shows the MMT packets MMTsyn to be synchronized with the actual SDH subtitle and the NTP timestamp NTP_{syn} of the packet in consideration of the delay time a expected until the MMT client apparatus 230 requests the switching to the SDH subtitle during the processing of the MMTcur that is transported from the first server 210 (program stream server) and currently arrives at the MMT client apparatus 230 and the MMT packet for the SDH subtitle is transported from the second server 250 (supplemental information server) and arrives at the MMT client apparatus 230 after the switching request to the SDH subtitle in the MMT client apparatus 230. Here, the MMT packet MMTsyn means the MMT packets transported from the first server 210 (program stream server).

When considering the case of FIG. 4, the second MMT packet of the SDH subtitle to be transported by the second server 250 (supplemental information server) needs to be sequentially transported by including data to be temporally synchronized with the MMTsyn.

From the results shown in FIG. 4, the MMT client apparatus 230 determines the NTP timestamp to be synchronized by the relationship of the following Equation 1.

NTP_{syn}=NTP_{cur}+α [Equation 1]

In Equation 1, the α value is set to be an appropriate value in consideration of the expected round-trip delay time consumed until the MMT client apparatus 230 requests the SDH subtitle to the second server 250 (supplemental information server) and receives the SDH subtitle data through a network.

That is, referring again to FIG. 6, the MMT client apparatus 230 transports the request message for the SDH subtitle data through the signaling of the S layer, for example, the S.2 layer to the second server 250 (supplemental information server), including the NTP0 and NTP_{syn} information that are the NTP timestamp value of the MMT packet first received from the first server 210 (program stream server) (S237). The second server 250 (supplemental information server) may use the NTP0 and NTP_{syn} information so as to detect the accurate temporal position of the SDH subtitle data to be received by the MMT client apparatus 230 from the request message.

FIG. 5 is a diagram showing the timing relationship between the MMT data to be considered by the second server 250 (supplemental information server) when the result obtained by storing the SDH subtitle data as the storage format of the MMT in the second server 250 (supplemental information server) and the SDH subtitle data requested from the MMT client apparatus 230 are transported by being carried on the MMT packets in the second server 250 (supplemental information server).

As the storage format of the MMT, the encapsulation format corresponding to the E-layer of the MMT may be used. The encapsulation format may include the timestamp information so as to provide the temporal synchronization of the stored media data. The timestamp information may be the sampling time for the media data and may also be decoding time or presentation time. Hereinafter, the case in which the sampling time as the time stamp information is used will be described. When the timestamp information is used as another time concept such as the decoding time or the presentation time in addition to the sampling time, the synchronization method of the present invention may be applied.

As shown in FIG. 5, the timestamp information such as the sampling time for synchronization of each MMT data is stored together with each of the MMT data 510-0, 510-1, . . . , 510-k, 510-k+1), and 510-n that is stored in the second server 250 (supplement information server).

Referring to FIG. 5, in order to perform the SDH subtitle data services requested from the MMT client apparatus 230 from accurate time, the MMT client apparatus 230 detects the temporal position of the SDH subtitle data corresponding to the time when the MMT client apparatus 230 wants to receive the services. To this end, the NTP0 and NTP_{syn} information transported from the MMT client apparatus 230 through the signaling of the foregoing S layer, for example, the S.2 layer is used.

The Start_Time_Offset that is the time representing how much the actual start time of the SDH subtitle data requested from the MMT client apparatus 230 lapses from the original start time of the SDH subtitle service is calculated as the universal time coordinated (UTC) time format by the following Equation 2 (S251a of FIG. 6).

Start_Time_Offset=NTP_{syn}−NTP0 [Equation 2]

In the Equation 2, the Start_Time_Offset represents the temporal difference value between the actual start time of the SDH subtitle data that is the requested media entity and the original start time of the SDH subtitle service. Next, the Start_Clock_Offest that is a result obtained by converting the Start_Time_Offset value in the same clock unit as the sampling time included in the header portions of each MMT storage data stored in the second server 250 (supplemental information server) is calculated by the following Equation 3 (S251b of FIG. 6).

Start_Clock_Offset=Start Time Offset×SCF [Equation 3]

The system clock frequency (SCF) to which the Equation 3 is applied represents the precision of the system time clock (STC) of the second server 250 (supplemental information server) used to extract the sampling time. In the MPEG-2 system and the RTP protocol, the SCF of 90 KHz precision is generally used.

The Start_Clcok_Offset value is a value obtained by converting the Start_Time-Offset with the precision of the system clock frequency (SCF) of the system time clock (STC) of the second server 250 (supplemental information server).

When the Start_Clock_Offset is determined, the sampling time (ST) value that is the sampling time recorded in the headers 310-0, 310-1, 310-2, and 310-n of each MMT data stored in the second server 250 (supplemental information server) is calculated using the following Equation 4 so as to detect the temporal position of the MMT data corresponding to the Start_Clock_Offset value (S251c of FIG. 6).

FIG. 5 shows that the MMT data corresponding to the sampling time STₖ that is the actual start time of the actual SDH subtitle service represents is temporally spaced by the Start_Clock_Offset from the ST₀ that is the original start time of the SDH subtitle service, wherein the sampling time STₖ that is the actual start time of the actual SDH subtitle service is obtained by the following Equation 4.

STₖ=ST₀+Start_Clock_Offset [Equation 4]

It is informed to the MMT client apparatus 230 through the signaling of the S layer, for example, S.2 layer that the second server 250 (supplemental information server) performs the sequential transport from the SDH subtitle data corresponding STₖ to the MMT client apparatus 230 (S253 of FIG. 6). In this case, it is informed that the NTP time value corresponding to the STₖ is also included in the signaling information of the S layer, for example, S.2 layer (signaling message).

Next, the second server 250 (supplemental information server) MMT-packetizes the MMT storage data to generate the second MMT packet (S257 of FIG. 6) and transport the MMT packet including the SDH subtitle to the MMT client apparatus 230 (S259 of FIG. 6).

When the SDH subtitle data corresponding to the STₖ accurately coinciding with the STₒ+Start_Clock_Offset value obtained by the above Equation 4 is present, the NTP time corresponding to the STₖ coincides with the NTP_{syn}. However, when the STₖ accurately coinciding with the STₒ+Start_Clock_Offset value is not present in the SDH subtitle data, the SDH subtitle data having the sampling time most approximating the STₒ+Start_Clock_Offset value is first served. In this case, the second server 250 (supplemental information server) transports the NTP time value corresponding to the sampling time STₖ of the MMT data to the MMT client apparatus 250 through the signaling of the S layer, for example, the S.2 layer to inform at what UTC time the corresponding SDH subtitle data are transported. Based on the information (the NTP time value corresponding to the STₖ), the MMT client apparatus 230 may know the accurate UTC time when the synchronization for the SDH subtitle is newly made and originally maintain the basic subtitle service previously transported until being reached at the time.

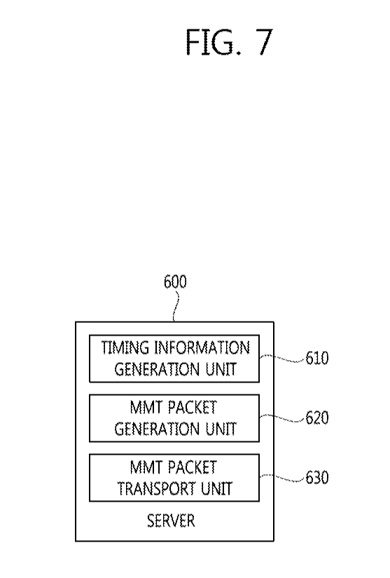

FIG. 7 is a block diagram of the server providing the timing information according to the embodiment of the present invention.

Referring to FIG. 7, a server 600 includes a timing information generation unit 610, an MMT packet generation unit 620, and an MMT packet transport unit 630 so as to generate the timing information and transmit the generated timing information to the MMT client apparatus 230. The server 600, which is a server generating the timing information, may be, for example, the second server 250 of FIG. 2.

The timing information generation unit 610 generates the foregoing timing information so as to synchronize between the packets including the second media entity and the packets including the first media entity. Here, the timing information may be included in the signaling message of the MMT S layer, for example, S.2 layer so as to be transported to the MMT client apparatus 230.

In detail, according to the media entity transport request like the SDH subtitle from the MMT client apparatus 230, the timing information generation unit 610 calculates the Start_Time_Offset that is the temporal difference value between the original start time and the actual start time of the media entity (SDH subtitle data) requested from the MMT client apparatus 230 by the foregoing Equation 2 and calculates the Start_Clock_Offset that is the result obtained by converting the Start_Time_Offset value in the same clock unit as the sampling time included in the header portions of each MMT storage data stored in the second server 250 by the foregoing Equation 3. In addition, the timing information generation unit 610 calculates the sampling time STₖ value that is the actual start time of the actual SDH subtitle service recorded in the headers of each of the MMT storage data stored in the second server 250 by the Equation 4.

The MMT packet generation unit 620 packetizes and generates the packets including the second media entity.

The MMT packet transport unit 630 transports the packets including the generated second media entity to the MMT client apparatus 230.

According to the method for providing timing information for synchronizing between the packet streams each transported from the first server and the second server through different channels or network under the hybrid delivery service environment based on the MMT (MPEG media transport) system and the method for synchronizing between the packet streams, in the case of the hybrid delivery service in which the plurality of media entities configuring the single service are transported from different servers, the timing information required to synchronize different media entities in the hybrid delivery service based on the MMT system through the signaling in the MMT S.2 layer adopted in the hierarchical structure of the MMT technology can be exchanged between the client and the server. Therefore, the server may detect the position of the corresponding media data from the MMT media data stored in the server at the service start time requested by the client based on the exchanged information and sequentially deliver the services to the client from the media data position.

As a result, the client can receive the services while smoothly maintaining the synchronization between the first media data receiving services in real time from the specific server and the second media data received by a new request to another server under the hybrid delivery service environment based on the MMT system.

That is, even though several MMT packet streams are transported to different channels or networks from different servers, the MMT client receiving the MMT packet streams can temporally synchronize the plurality of MMT packet streams so as to be simultaneously displayed on the screen.

While the present invention has been shown and described in connection with the embodiments, it will be apparent to those skilled in the art that modifications and variations can be made without departing from the spirit and scope of the invention as defined by the appended claims.

What is claimed is:

1. A method for providing timing information for synchronizing between packet streams each transported from a first server and a second server under environment of a hybrid delivery service, the first server transporting a first media entity and the second server transporting a second media entity, the method comprising:
generating timing information for synchronizing a second packet including a second media entity with a first packet including a first media entity in the second server in response to a transport request for the second media entity from a client; and
providing the timing information and the second packet including the second media entity to the client from the second server.

2. The method of claim 1, wherein the timing information is provided to the client, being included in a signaling message of an MMT S.2 layer.

3. The method of claim 1, wherein the client calculates a network time protocol (NTP) timestamp value NTP0 of an MMT packet first received from the first server, an NTP timestamp NTP_{cur} at the time of a transport request for the second media entity to the first packet including the first media entity transported from the first server and arriving at the client, and an NTP timestamp NTP_{syn} at the time of synchronization with the second media entity to be newly received in future by the following Equation.
NTP_{syn}=NTP_{cur}+α
where α represents a delay time expected until the second packet including the second media entity is transported from the second server after a switching request to the second media entity and arrives at the client.

4. The method of claim 3, wherein the generating of the timing information for synchronizing the second packet including the second media entity in the second server with the first packet including the first media entity in response to the transport request for the second media entity from the client further includes calculating Start_Time_Offset that is a temporal difference value between an original start time and an actual start time of the second media entity service in the second server as a universal time coordinated (UTC) time format by the following Equation.
StartTime_Offset=NTP_{syc}−NTPo.

5. The method of claim 4, wherein the generating of the timing information for synchronizing the second packet including the second media entity in the second server with the first packet including the first media entity in response to the transport request for the second media entity from the client further includes calculating a Start_Clock_Offset value obtained by converting the Start-Time-Offset with system clock frequency (SCF) precision of a system time clock (STC) of the second server by the following Equation.
Start_Clock_Offset=Start_Time_Offset×SCF.

6. The method of claim 5, wherein the generating of the timing information for synchronizing the second packet including the second media entity in the second server with the first packet including the first media entity in response to the transport request for the second media entity from the client further includes calculating a sampling time STₖ corresponding to an actual start time of the second media entity by the following Equation so as to detect a temporal position of an MMT data corresponding to the Start_Clock_Offset value.
STₖ=STₒ+Start_Clock_Offset
where STₒ is a sampling time corresponding to an original start time of the second media entity.

7. The method of claim 1, wherein the second server includes the NTP timestamp corresponding to the actual start time of the second media entity in the signaling message of the MMT S.2 layer so as to be transported to the client.

8. The method of claim 1, wherein the second server is a supplemental information server transporting data including supplemental information through a broadband channel and the first server is a program stream server transporting data including broadcast contents through a broadcast channel.

9. A method for synchronizing between packet streams each transported from a first server and a second server under environment of a hybrid delivery service, the method comprising:
requesting a transport of a second media entity to a second server through a second network during playing of a first media entity received through a first network from the first server in a client;
receiving timing information for synchronizing a second packet including the second media entity with a first packet including the first media entity in the client from the second server; and
determining whether the first packet including the first media entity and the second packet including the second media entity are synchronized with each other by using the timing information in the client.

10. The method of claim 9, wherein the client receives the timing information included in a signaling message of an MMT S.2 layer from the second server.

11. The method of claim 9, wherein the client calculates a network time protocol (NTP) timestamp value NTP0 of an MMT packet first received from the first server, an NTP timestamp NTP_{cur} at the time of a transport request for the second media entity to the first packet including the first media entity transported from the first server and arriving at the client, and an NTP timestamp NTP_{syn} at the time of synchronization with the second media entity to be newly received in future by the following Equation.
NTP_{syn}=NTP_{cur}+α
where α represents a delay time expected until the second packet including the second media entity is transported from the second server after a switching request to the second media entity and arrives at the client.

12. The method of claim 9, wherein the determining whether the first packet including the first media entity and the second packet including the second media entity are synchronized with each other by using the timing information in the client performs synchronization when a difference value between first absolute time information Absolute_Presentation_Time of the first packet and second absolute time information Absolute_Presentation_Time of the second packet is smaller than the reference value to play the first and second packets together.

13. A server for providing timing information so as to synchronize between packet streams each transported from a first server and a second server under environment of a hybrid delivery service, the first server transporting a first media entity and the second server transporting a second media entity, the server comprising:
a timing information generation unit generating timing information for synchronizing a second packet including a second media entity with a first packet including a first media entity by the second server in response to a transport request for the second media entity from a client;
an MMT packet generation unit packetizing and generating the packets including the second media entity, and
an MMT packet transport unit transporting the packet including the generated second media entity to the client.

14. The server of claim 13, wherein the timing information generation unit includes the timing information included in a signaling message of an MMT S.2 layer so as to be transported to the client.
